(19) United States
(12) Patent Application Publication
(10) Pub. No.: US 2023/0317958 A1
(43) Pub. Date: Oct. 5, 2023

(54) GRAPHENE DISPERSION, GRAPHENE RESIN POWDER, AND BATTERY

(71) Applicant: KYOCERA Corporation, Kyoto-shi, Kyoto (JP)

(72) Inventor: Akira KUME, Saitama-shi (JP)

(73) Assignee: KYOCERA Corporation, Kyoto-shi, Kyoto (JP)

(21) Appl. No.: 18/023,254

(22) PCT Filed: Aug. 27, 2021
(86) PCT No.: PCT/JP2021/031480

§ 371 Date: Feb. 24, 2023

(30) Foreign Application Priority Data
Aug. 28, 2020 (JP) 2020-144599

(51) Int. Cl. H01M 4/62

(52) U.S. Cl. CPC H01M 4/625; H01M 4/622; H01M 2004/027

(57) ABSTRACT

Provided is a graphene dispersion in which graphene and a polymer are dispersed or dissolved in a solvent. The weight-average molecular weight of the polymer is from 10000 to 800000. A viscosity of the graphene dispersion measured using a B-type viscometer at a measurement temperature of 25° C. and a rotational speed of 50 rpm is from 500 to 10000 (mPa·s). A value obtained by dividing the viscosity of the graphene dispersion measured using the B-type viscometer at a measurement temperature of 25° C. and a rotational speed of 5 rpm by the viscosity of the graphene dispersion measured using the B-type viscometer at a measurement temperature of 25° C. and a rotational speed of 50 rpm is from 1.2 to 5.0.

### TECHNICAL FIELD

The present disclosure relates to a graphene dispersion, a graphene resin powder, and a battery, and particularly relates to a graphene dispersion, a graphene resin powder obtained by drying the graphene dispersion, and a battery obtained using the graphene resin powder.

### BACKGROUND OF INVENTION

Graphene is a substance containing a two-dimensional crystal composed of carbon atoms and is a material attracting a great deal of attention. Graphene has excellent electrical, thermal, optical, and mechanical properties. Graphene is expected to have a broad range of applications in areas such as, for example, graphene-based composite materials, nanoelectronics, flexible/transparent electronics, nanocomposite materials, supercapacitors, batteries, hydrogen storage, nanomedicine, and bioengineered materials. In particular, films in which graphene is dispersed are anticipated as electromagnetic wave-shielding materials, electromagnetic wave-absorbing materials, electrode materials for fuel cells, and heat-dissipating materials.

To form a film in which graphene is dispersed, the graphene must be dispersed in a dispersion medium. Here, as an example of graphene dispersed in a dispersion medium, a dispersion in which a thermoplastic resin and a carbon material having a graphene structure are dissolved or dispersed in a halogenated aromatic solvent is known (see Patent Document 1). Another known example of graphene dispersed in a dispersion medium is a dispersion in which graphene is stably dispersed in a solvent by polymethylpyrrolidone (see Patent Document 2).

### CITATION LIST

### Patent Literature

Patent Document 1: JP 2012-224810 A
Patent Document 2: JP 2014-009104 A

### SUMMARY

The present disclosure relates to the following:
(1) A graphene dispersion in which graphene and a polymer are dispersed or dissolved in a solvent, wherein a weight-average molecular weight of the polymer is from 10000 to 800000, a viscosity of the graphene dispersion measured using a B-type viscometer at a measurement temperature of 25° C. and a rotational speed of 50 rpm is from 500 to 10000 (mPa·s), and a value obtained by dividing a viscosity of the graphene dispersion measured using the B-type viscometer at a measurement temperature of 25° C. and a rotational speed of 5 rpm by the viscosity of the graphene dispersion measured using the B-type viscometer at a measurement temperature of 25° C. and a rotational speed of 50 rpm is from 1.2 to 5.0.
(2) A graphene resin powder obtained by drying the graphene dispersion described in (1) above.
(3) A battery in which the graphene resin powder described in (2) is used.

### DESCRIPTION OF EMBODIMENTS

Graphene tends to aggregate due to van der Waals' forces, and therefore favorably dispersing graphene in a dispersion medium is difficult. In addition, when the solvent in a graphene dispersion is dried to produce a film, the graphene may be reaggregated, resulting in a decrease in dispersibility. Moreover, when a dispersion contains a large amount of polymer and the dispersion is formed into a film, the polymer component is present on the surface of the film and may cause an increase in surface resistance and a decrease in conductivity. Further, when the dispersion contains polyvinyl pyrrolidone, formation of a film may not be possible.

The present inventors dispersed graphene and a polymer of a predetermined weight-average molecular weight in a solvent and adjusted the mixture to achieve a viscosity value in a predetermined range, the viscosity value being measured using a B-type viscometer at a measurement temperature of 25° C. and a rotational speed of 50 rpm (hereinafter, the viscosity measurement is a value measured using the B-type viscometer). The present inventors also adjusted the mixture to achieve a value in a predetermined range, the value being obtained by dividing the viscosity at a measurement temperature of 25° C. and a rotational speed of 5 rpm by the viscosity at a measurement temperature of 25° C. and a rotational speed of 50 rpm. As a result, the present inventors discovered that a graphene dispersion exhibiting excellent dispersibility and which can be used to form a graphene resin film having high conductivity is obtained.

The inventors also found that when a graphene resin powder obtained by drying the resulting graphene dispersion is again dissolved in a solvent, a graphene dispersion with excellent dispersibility is obtained. The inventors further discovered that when a film is formed using the graphene dispersion, the film formation properties (dispersibility) are good.
The present inventors also discovered that when the graphene resin powder is used in a negative electrode material of a secondary battery, a battery having a high discharge capacity retention rate is obtained.

Hereinafter, the present disclosure will be described in detail with reference to an embodiment.

In the present description, wording of “from XX to YY” refers to “XX or greater and YY or less”. In the present description, with regard to numerical ranges (e.g., ranges such as content), lower and upper limit values described in a stepwise manner may each be independently combined. In a numerical range described herein, the upper or lower limit value of the numerical range may be replaced by a value presented in the examples.
In the present description, “graphene” means a “sheet-shaped substance containing sp2-bonded carbon atoms and having 10 or fewer layers”.
In the present description, “modified graphite” refers to a “sheet-shaped substance (not containing graphene) containing sp2-bonded carbon atoms and having from more than 10 to 2000 or fewer layers, the size (long side) being from 0.1 nm to 50 μm.” The size of the “modified graphite” was measured using a scanning electron microscope (model S-3400 NX available from Hitachi High-Tech Corporation). The thickness of the “modified graphite” was obtained by calculating the number of layers from the crystal thickness and interlayer spacing of (002) diffraction lines using an X-ray diffractometer (model X'Pert PRO available from Malvern Panalytical Ltd.).
As used herein, the term “graphene resin powder” means “a powder having resin covering the periphery of graphene and modified graphite”.

Graphene Dispersion

The graphene dispersion of the present embodiment contains graphene, a polymer, and a solvent, and as necessary, further contains modified graphite and other components. Note that the dispersibility of the graphene dispersion can be measured by absorbance using a spectrophotometer as described in the examples.

The viscosity of the graphene dispersion is not particularly limited as long as it is from 500 to 10000 mPa·s when measured at a measurement temperature of 25° C. and a rotational speed of 50 rpm, and may be from 700 to 8000 mPa·s.

When the viscosity of the graphene dispersion is 500 mPa·s or greater when measured at a measurement temperature of 25° C. and a rotational speed of 50 rpm, structural viscosity is easily expressed, and the graphene is less likely to aggregate. On the other hand, when the viscosity of the graphene dispersion is 10000 mPa·s or less when measured at a measurement temperature of 25° C. and a rotational speed of 50 rpm, workability such as coatability can be improved.

The viscosity of the graphene dispersion when measured at a measurement temperature of 25° C. and a rotational speed of 5 rpm is not particularly limited, and may be from 600 to 50000 mPa·s, or may be from 840 to 40000 mPa·s. When the viscosity of the graphene dispersion measured at a measurement temperature of 25° C. and a rotational speed of 5 rpm is 600 mPa·s or greater, the viscosity becomes greater than the surface tension of the solvent, and a uniform coating film is obtained. On the other hand, when the viscosity of the graphene dispersion measured at a measurement temperature of 25° C. and a rotational speed of 5 rpm is 50000 mPa·s or less, workability such as coatability can be improved, and a continuous coating film with no uncoated locations is obtained.

The value obtained by dividing the viscosity of the graphene dispersion measured at a rotational speed of 5 rpm by the viscosity of the graphene dispersion measured at a rotational speed of 50 rpm (the value thereof may be referred to as a “viscosity ratio” below) is not particularly limited as long as the value is from 1.2 to 5.0, and may be from 2.0 to 4.0. When the viscosity ratio is greater than or equal to the lower limit value described above, the graphene dispersion expresses structural viscosity. This is because secondary bonds between macromolecules of the polymer exhibit a repulsive force that is nearly ten times that of the van der Waals' forces between the graphenes. Therefore, even when highly concentrated, the graphene is stably dispersed, and aggregation of the graphene and the modified graphite can be reduced. Furthermore, when the viscosity ratio is equal to or less than the upper limit value described above, the graphene dispersion exhibits moderate fluidity. Therefore, the graphene dispersion has good coatability when forming a film, and can form a continuous homogeneous film.

Examples of a method for adjusting the viscosity ratio to within the above range (to obtain optimum structural viscosity) include, for example, using a predetermined anionic polymer as the polymer, using a predetermined amount (a relatively small amount) of a polymer having a large weight-average molecular weight, and using a polymer having a degree of etherification of from 0.5 to 2.2.

Note that “degree of etherification” in the present description is a value measured by a nitric acid-methanol method.

Graphene

The graphene is not particularly limited as long as the graphene becomes graphene in a graphene dispersion. As the graphene, for example, a graphene obtained using modified graphite as a raw material may be used.
The method of producing graphene from the modified graphite is not particularly limited. Examples of the method include a mechanical exfoliation method, a CVD method, an oxidation-reduction method, and a chemical exfoliation method. Of these methods, a single method may be used alone, or two or more methods may be used in combination.
The content of carbon atoms in the graphene is not particularly limited, and may be 95 mass % or more, 99 mass % or more, or 100 mass %.
The content of impurities in the graphene is not particularly limited, and may be 5 mass % or less, 1 mass % or less, or 0 mass %.
The size of the graphene is not particularly limited, and may be from 0.1 nm to 50 μm, from 0.5 nm to 10 μm, or from 0.1 μm to 2 μm. Note that the size of the graphene is the longer (long side) of the vertical and lateral lengths of the graphene.
When the size of the graphene is 0.1 nm or greater, the coefficient of thermal conductivity of the graphene is improved. On the other hand, when the size of the graphene is 50 μm or smaller, the dispersibility of the graphene is improved.

The content of graphene in the graphene dispersion is not particularly limited, and may be from 0.1 mass % to 25 mass %, from 1.0 mass % to 15 mass %, or from 3.0 mass % to 10 mass %, relative to the solvent in the graphene dispersion.

Modified Graphite

Modified graphite can be produced, for example, from natural graphite.
The modified graphite may not contain atoms other than carbon atoms, or may contain atoms other than carbon atoms. For example, the modified graphite may contain oxygen atoms at an amount of 10 mass % or less. When the content of oxygen atoms is 10 mass % or less, the coefficient of thermal conductivity of the obtained graphene is improved.
The content of carbon atoms in the modified graphite is not particularly limited, and may be from 70 mass % to 100 mass %, from 80 mass % to 98 mass %, or from 85 mass % to 95 mass %.
The size of the modified graphite is not particularly limited as long as the size is from 0.1 nm to 50 μm, and the size may be from 0.5 nm to 20 μm. Note that the size of the modified graphite is the longer of the vertical and lateral lengths (long side) of the modified graphite. When the size of the modified graphite is 0.1 nm or greater, the coefficient of thermal conductivity of the modified graphite is improved. On the other hand, when the size of the modified graphite is 50 μm or smaller, the dispersibility of the modified graphite is improved.

The number of layers of modified graphite is not particularly limited as long as the number of layers is greater than 10 and equal to or less than 2000. From the perspectives of improving bending and dispersibility, the number of layers of modified graphite may be from greater than 10 to less than or equal to 200, or from greater than 10 to less than or equal to 30.

Polymer

The polymer has a weight-average molecular weight of from 10000 to 800000 and dissolves or disperses in a solvent. The polymer is not particularly limited as long as the polymer exhibits a property (structural viscosity property) of having a high viscosity at a low shear rate in the dispersion and undergoing a decrease in viscosity at a high shear rate. The polymer may be a water-soluble polymer or a non-water-soluble polymer, and may be an anionic polymer. Also, if the polymer has a strong affinity for graphene, the polymer more easily covers the graphene. Therefore, the graphene and modified graphite are less likely to aggregate or precipitate, and the graphene dispersion can be stored for a long period of time.
Note that in the present description, the “weight-average molecular weight of the polymer” can be measured by the gel permeation chromatography method (using the HLC-8120GPC gel permeation chromatography (GPC) device available from Tosoh Corporation and the TSK-GEL column (α-M×qty. of 2) available from Tosho Corporation, flow rate: 1 mL/min) using, as a standard substance, polystyrene with a known molecular weight.

Aqueous Polymer

The aqueous polymer is not particularly limited, and examples thereof include thickening polysaccharides having a gelling ability such as xanthan gum, welan gum, succinoglycans, guar gum, locust bean gum, tamarind gum, pectin, and derivatives thereof, carboxymethyl cellulose (CMC) salts, hydroxyethyl cellulose, alginates, glucomannan, agar, and lambda (λ) carrageenan; synthetic resins such as polymers and cross-linkable acrylic acid polymers having a weight-average molecular weight of from 100000 to 150000 and containing, as main constituents, an alkyl methacrylate or a polyvinyl alcohol having a weight-average molecular weight of 100000 to 150000; and PEG-based HLB8 to HLB12 nonionic thickeners (surfactants).

Anionic Polymer

The functional group contained in the anionic polymer is not particularly limited, and examples include a carbonyl group, a hydroxyl group, a sulfonate group, and a phosphate group.
The anionic polymer is not particularly limited, but from the perspective of forming hydrogen bonds between hydroxyl groups and easily exhibiting structural viscosity, the anionic polymer may be a natural or semi-synthetic polymeric carboxylic acid. Examples thereof include a salt having a carboxyl group such as an alginic acid, carboxymethyl cellulose, hydroxycarboxymethyl cellulose, carboxymethylated starch, gum arabic, tragacanth gum, and pectin hyaluronic acid.

The content of the polymer in the graphene dispersion is not particularly limited, and may be from 1 to 100 mg/g or from 5 to 50 mg/g in relation to the solvent in the graphene dispersion. When the content of the polymer in the graphene dispersion is 1 mg/g or more, structural viscosity is expressed, and the graphene is less likely to aggregate. On the other hand, when the content of the polymer in the graphene dispersion is 100 mg/g or less, the decrease in surface resistance when a film is formed and the coatability (workability) of the graphene dispersion are improved.

The weight-average molecular weight of the polymer is not particularly limited as long as the weight-average molecular weight is from 10000 to 800000, and may be from 50000 to 600000, or from 100000 to 500000. When the weight-average molecular weight of the polymer is greater than or equal to 10000, the viscosity ratio of the graphene dispersion can be adjusted to 1.2 or higher, the graphene dispersion exhibits structural viscosity, and the graphene is less likely to aggregate. On the other hand, when the weight-average molecular weight of the polymer is 800000 or less, workability such as coatability is improved.

The degree of etherification of the polymer is not particularly limited, and may be from 0.5 to 2.2, or from 0.7 to 1.5. When the degree of etherification of the polymer is from 0.5 to 2.2, structural viscosity is more easily expressed.

Typically, a polymer may be used as a thickener for dispersing a nanofiller. When this is done, the blending amount of the polymer (thickener) is usually at least 200 mg/g or more in relation to the solvent. A solid such as a filler adsorbs the polymer (thickener), resulting in a reduction in the concentration of the polymer (thickener) in the solvent. Therefore, a large amount of polymer (thickener) is required to obtain the structural viscosity required for the nanofiller to be dispersed. However, when the blending amount of the polymer (thickener) is large and a film is formed, the polymer (thickener) increases the surface resistance, resulting in a worsening of electrical conductivity.

In the graphene dispersion of the present embodiment, graphene is the dispersed substance, and therefore the adsorption amount of the polymer (thickener) to the solid is low due to the shape of the graphene. Even in a small amount of less than 200 mg/g, the polymer (thickener) can improve dispersibility and can reduce surface resistance.

Solvent

The solvent is not particularly limited as long as the solvent disperses graphene and dissolves or disperses the polymer.
A polar solvent is not particularly limited, and examples include water, methanol, ethanol, 1-propanol, 2-propanol (isopropyl alcohol (IPA)), butanol, acetone, acetonitrile, tetrahydrofuran, dimethyl sulfoxide, dimethylacetamide, N,N-dimethylformamide, and N-methylpyrrolidone. Of these solvents, a single type may be used alone, or two or more types may be used in combination. Among these, from the perspective of miscibility with graphene, any of water, methanol, ethanol, 1-propanol, 2-propanol, N-methylpyrrolidone, N,N-dimethylformamide, and a mixed solvent of at least two types of these may be selected. A mixed solvent containing water and an alcohol may be selected, and a mixing ratio (volume ratio) of water to 2-propanol may be selected from 50/50 to 70/30.
Note that when a nonpolar solvent is used as the solvent, the solvent does not easily disperse the graphene.

Other Components

The graphene dispersion of the present embodiment may include other components. The other components are not particularly limited, and for example, the graphene dispersion may contain a nanofiller; a filler (excluding nanofillers) such as expanded graphite and flake graphite; and an additive such as a thickener, a viscosity modifier, a resin, a curing agent, a flame retardant foaming agent, and a UV absorber.
The total amount of the graphene, the modified graphite, and the polymer having a weight-average molecular weight of from 10000 to 800000 in the solid content (i.e., the components excluding the solvent) of the graphene dispersion of the present embodiment may be 60 mass % or more, 80 mass % or more, 90 mass % or more, 95 mass % or more, or 100 mass %.

Method for Preparing Graphene Dispersion

The method for producing the graphene dispersion of the present embodiment is not particularly limited, and a known method for producing a graphene dispersion can be used.
For example, a method may be used in which modified graphite is inserted into a solvent and subjected to liquid phase exfoliation through ultrasonic dispersion or the like to exfoliate the modified graphite to a graphene state, after which a polymer is inserted, the mixture is mixed in a vacuum state using mechanical stirring or the like, and a graphene dispersion is obtained. The amount of modified graphite inserted into the solvent may be from 5 to 100 mg/g, or from 10 to 70 mg/g. When the amount of modified graphite inserted into the solvent is too low, the concentration of graphene in the resulting graphene dispersion is low. On the other hand, when the amount of the modified graphite inserted into the solvent is too large, the modified graphite is not easily exfoliated and does not easily become graphene.

Graphene Resin Film

A graphene resin film is formed using the graphene dispersion of the present embodiment.

Method for Producing Graphene Resin Film from Graphene Dispersion

In the graphene dispersion of the present embodiment, graphene is present almost homogeneously in the solvent, and modified graphite may also be present almost homogeneously. As a result, a film formed using the graphene dispersion has good film-forming properties and contains graphene almost uniformly. The method of manufacturing a film formed using the graphene dispersion of the present embodiment is not particularly limited, and examples thereof include a method in which the graphene dispersion is applied onto a desired surface of a substrate, and the graphene dispersion is solidified to form a film.

The material of the substrate for forming a film formed using the graphene dispersion of the present embodiment is not particularly limited as long as the desired film can be formed. Examples of the substrate material include ceramics, such as glass, silica, alumina, titanium oxide, silicon carbide, silicon nitride, and aluminum nitride; metals, such as silicon, aluminum, iron, and nickel; and thermoplastic resins, such as acrylic resin, polyester, polycarbonate, polyamide, polyimide, polyphenylene sulfide, polyether ether ketone, polyphenylene ether, polyether nitrile, polyamide imide, polyethersulfone, polysulfone, and polyetherimide.

The substrate for forming a film formed using the graphene dispersion of the present embodiment is not particularly limited as long as a film formed using the graphene dispersion can be formed. Examples of the substrate include a film-shaped body (including a textile or nonwoven fabric formed from fibers), such as a film or a sheet; a molded body other than a film-shaped body; and a powdered granular body.

In order to improve adhesiveness with the film formed using the graphene dispersion of the present embodiment, the substrate surface may be subjected to a corona discharge treatment or a plasma discharge treatment.

As the application method for forming a film formed using the graphene dispersion of the present embodiment, various general application methods can be employed according to the viscosity of the graphene dispersion and the shape and size of the desired film. The application method is not particularly limited, and examples include a casting and immersion method, a doctor blade coating method, a knife coating method, a bar coating method, a spin coating method, a gravure coating method, a screen coating method, and a spray method through spraying.

After the graphene dispersion is applied onto a substrate, the substrate coated with the graphene dispersion may be subjected to a heating treatment to remove the dispersion medium in the graphene dispersion. The heating treatment temperature differs depending on the volatility of the solvent, the type of substrate, the heating atmosphere, and the function to be imparted through the shaping property of the coating film. When the substrate is a ceramic or a metal, the heating treatment temperature is from 50 to 300° C., and when the substrate is a thermoplastic resin, the heating treatment temperature is from 20 to 250° C. These temperatures are not particularly limited as long as the temperature does not cause alteration of the graphene and substrate.

The film formed using the graphene dispersion of the present embodiment may be affixed on the substrate, or may be detached from the substrate. When affixed on the substrate, the film can impart a function such as electrical conductivity, thermal conductivity, and electromagnetic wave absorption to the substrate.

The film thickness of the film formed using the graphene dispersion of the present embodiment is not particularly limited, and may be 50 μm or less, or 30 μm or less. If the film thickness of the film is 50 μm or less, a decrease in leveling properties or the like is unlikely to occur. Note that the lower limit value of the film thickness is not particularly limited as long as the film thickness is in a range in which a uniform film is obtained.

Molded Product, Other than Film, Formed Using Graphene Dispersion In addition to use in the formation of a film, the graphene dispersion of the present embodiment can be used as a material of a molded product in which the graphene dispersion and another organic polymer material and the like are mixed. For example, the graphene dispersion can be used as a material of a molded product having electrical conductivity, thermal conductivity, or an electromagnetic wave absorption property. In particular, the graphene dispersion can be used as a material of a molded product requiring electrical conductivity, such as an electrode.

Graphene Resin Powder

The graphene resin powder of the present embodiment is obtained by drying the graphene dispersion of the present embodiment.

Even if the graphene resin powder obtained by drying the graphene dispersion is dispersed once again in a solvent to form a film, the film can be formed without aggregation of the graphene or of a mixture of the graphene and the modified graphite.

The method of drying the graphene dispersion to produce the graphene resin powder is not particularly limited. For example, a method may be used in which the solvent in the graphene dispersion is volatilized through heating under vacuum conditions at a temperature from 60 to 120° C. to thereby produce the graphene resin powder.
The method of re-dissolving or re-dispersing the graphene resin powder in a solvent is not particularly limited, and for example, a method may be used in which the graphene resin powder is inserted into a solvent, and the mixture is stirred using mechanical agitation, ultrasonic waves, a high pressure homogenizer, or the like at a predetermined temperature (may be ambient temperature).
The solvent that redissolves the graphene resin powder is not particularly limited. Examples thereof include polar solvents such as water, methanol, ethanol, 1-propanol, 2-propanol, butanol, acetone, acetonitrile, tetrahydrofuran, dimethyl sulfoxide, dimethylacetamide, N,N-dimethylformamide, and N-methylpyrrolidone. Of these solvents, a single type may be used alone, or two or more types may be used in combination. Among these, from the perspective of miscibility with graphene, any of water, methanol, ethanol, 1-propanol, 2-propanol, N-methylpyrrolidone, N,N-dimethylformamide, and a mixed solvent of at least two types of these may be selected.
The method of forming a film using a dispersion in which the graphene resin powder is re-dissolved is not particularly limited, and a method similar to that of the method for forming a film using a graphene dispersion can be used.

Negative Electrode Graphene Dispersion

The graphene resin powder of the present embodiment can be used as a negative electrode graphene dispersion by adding a negative electrode active material and a graphene dispersion binder for a negative electrode.

Negative Electrode Active Material

The negative electrode active material is not particularly limited as long as the negative electrode active material can dope or intercalate lithium ions. Examples of the negative electrode active material include metal Li; alloy-based materials such as tin alloys, silicon alloys, and lead alloys that are alloys of metal Li; metal oxide-based materials, such as LiₖFe₂O₃ (in this paragraph, k represents 0<k≤4), LiₖFe₃O₄, and LiₖWO₂; electrically conductive polymer-based materials such as polyacetylene; amorphous carbonaceous materials such as hard carbon; artificial graphite such as highly graphitized carbon materials; carbonaceous powders such as natural graphite; and carbon-based materials such as carbon black and carbon fibers. One type of these negative electrode active materials may be used alone, or a plurality may be combined and used.

Graphene Dispersion Binder for Negative Electrode

The graphene dispersion binder for a negative electrode is not particularly limited as long as the graphene dispersion binder is used to bind particles such as an active material and an electrically conductive carbon material, or to bind an electrically conductive carbon material and a current collector. Examples of the graphene dispersion binder for a negative electrode include acrylic resin; polyurethane resin; a cellulose resin such as carboxymethyl cellulose; a synthetic rubber such as styrene-butadiene rubber and fluororubber; an electrically conductive resin such as polyacteylene; and a polymeric compound including a fluorine atom such as polyvinylidene fluoride. The graphene dispersion binder for a negative electrode may be a modified product, a mixture, or a copolymer of these resins. One or more types of these binders may be used alone, or a plurality may be combined and used. When the binder is to be used in an aqueous mixed ink, a water medium can be used as the binder. Examples of forms of the binder of the water medium includes a water-soluble form, an emulsion form, and a hydrosol form, and the form thereof can be selected as appropriate.

A film-formation aid, an antifoaming agent, a leveling agent, an antiseptic, a pH adjusting agent, a viscosity modifier, and the like can be blended, as necessary, into the graphene dispersion for a negative electrode.

The negative electrode graphene dispersion can be used in a lithium ion secondary battery electrode, an electrode for an electric double layer capacitor, a primer layer of a lithium ion capacitor, and the like.

Battery Negative Electrode Mixture Layer

A battery negative electrode mixture layer can be obtained by coating a current collector with the graphene dispersion for a negative electrode and drying the coated current collector.

Current Collector

The material and shape of the current collector used in the electrode are not particularly limited, and a current collector used in various batteries can be selected as appropriate. Examples of the material of the current collector include metals such as aluminum, copper, nickel, titanium, and stainless steel; and alloys of at least two types of these metals. Also, although a foil on a flat plate is commonly used as the shape of the current collector, a current collector with a roughened surface, a current collector having a perforated foil shape, and a current collector having a mesh shape can also be used.

The method for coating the current collector with the graphene dispersion for an electrode is not particularly limited, and a known method can be used. Examples of such methods include die coating, dip coating, roll coating, doctor coating, knife coating, spray coating, gravure coating, screen printing, and electrostatic coating. As the drying method, blow drying, hot air drying, infrared heat drying, and far-infrared heat drying can be used, but the drying method is not particularly limited thereto. After being coated, the current collector may be subjected to a rolling process using a flat press, a calendar roll, or the like.

Battery

The battery of the present embodiment is, for example, a lithium ion secondary battery using a negative electrode that is a battery negative electrode mixture layer, a positive electrode, an electrolytic solution, a separator, and the like.
A lithium ion secondary battery is described as an example below.

Electrolytic Solution

An electrolytic solution obtained by dissolving and electrolyte containing lithium in a non-aqueous solvent can be used as the electrolytic solution. The non-aqueous solvent is not particularly limited, and examples include carbonates such as ethylene carbonate and propylene carbonate; lactones such as γ-butyrolactone and γ-valerolactone; cyclic ethers such as tetrahydrofuran and 2-methyltetrahydrofuran; and esters such as methyl formate and methyl acetate. Each of these non-aqueous solvents may be used alone, or two or more types may be mixed and used. Furthermore, the electrolytic solution can be retained in a polymer matrix to form a gel-like polymer electrolyte. Examples of the polymer matrix include, but are not limited to, acrylate-based resins having a polyalkylene oxide segment, polyphosphazene-based resins having a polyalkylene oxide segment, and polysiloxanes having a polyalkylene oxide segment.

Examples of the electrolyte include, but are not limited to, LiBF₄, LiPF₆, LiAsF₆, LiSbF₆, and LiCF₃SO₃.

Separator

Examples of the separator include, but are not limited to, polyethylene nonwoven fabrics, polypropylene nonwoven fabrics, polyamide nonwoven fabrics, and these nonwoven fabrics subjected to hydrophilic treatment.

### EXAMPLES

The present disclosure is specifically described through examples; however, the present disclosure is not limited in any way to these examples.

### Example 1

### Method for Preparing Graphene Dispersion

An amount of 20.00 g of modified graphite-1 (available from XG Sciences, Inc., grade M, size (long side): 15 μm, number of layers: 20) was inserted into 575.00 g of a mixed solvent of deionized water and 2-propanol (volume ratio: 60/40) as a solvent, and then treated with an ultrasonic homogenizer (UH-600S, available from SMT Co., Ltd.) for 60 minutes to obtain graphene from the modified graphite. Subsequently, 28.80 g of carboxymethylated starch (trade name: carboxymethylated starch, available from Nippon Starch Chemical Co., Ltd., weight-average molecular weight: 180000, degree of etherification: 0.90 to 1.10) was added as a polymer. The components were mixed for 20 minutes in a vacuum state using a planetary mixer, and a graphene dispersion was prepared. The prepared graphene dispersion was used as a dispersion 1.
The evaluation described below was conducted using the obtained dispersion 1. The evaluation results are shown in Table 1-1.

Graphene Dispersion Evaluation Method

### Graphene Concentration Measurement, Modified Graphite Concentration Measurement, Polymer Concentration Measurement

An amount of 20.00 g of modified graphite-1 (available from XG Sciences, Inc. grade M, size (long side): 15 μm, number of layers: 20) was inserted into 575.00 g of a mixed solvent of deionized water and 2-propanol (volume ratio: 60/40) as a solvent, and then treated with an ultrasonic homogenizer (UH-600S, available from SMT Co., Ltd.) for 60 minutes. An amount of 100.00 g of the resulting product was centrifuged using a centrifuge (model: R-22N, available from Hitachi Koki Co., Ltd., 1000 rpm, 10 minutes), and 90.00 g of a supernatant liquid and 10.00 g of a precipitated residue were obtained. The 90.00 g of the supernatant liquid was dried at 100° C. to volatilize the solvent, after which a solid content of 0.62 g was obtained. Thus, the 90.00 g of the supernatant liquid contained 0.62 g of graphene and 89.38 g of solvent. The graphene concentration (mg/g) was calculated by dividing graphene mass (0.62 g) by the solvent mass (89.38 g).
Note that the amount (g) of graphene in Table 1-1 and Table 1-2 is a value obtained by multiplying the calculated graphene concentration (mg/g) by the blended amount (g) of the solvent.
Also, in Table 1-1 and Table 1-2, the modified graphite concentration (mg/g) is a value obtained by dividing the insertion amount (mg) of the modified graphite by the blended amount (g) of the solvent, and the polymer concentration (mg/g) is a value obtained by dividing the blended amount (mg) of the carboxymethylated starch as a polymer by the blended amount (g) of the solvent.

Graphene Size Measurement

The graphene size (long side) was confirmed to be 0.70 μm using an atomic force microscope (model: AFM/SPM7500, available from Keysight Technologies). An AFM sample was prepared by spray coating the graphene dispersion onto cleaved mica and drying.

Measurement of Number of Layers of Graphene

The thickness of the graphene was measured using an atomic force microscope (model: AFM/SPM7500, available from Keysight Technologies). From the measurement result, the number of graphene layers was determined to be 10 or fewer, and conversion of the modified graphite-1 into graphene was confirmed. An AFM sample was prepared by spray coating the graphene dispersion onto cleaved mica and drying.

Measurement of Graphene Dispersion Viscosity

Using a B-type viscometer (available from Horiba, Ltd., body: LVT, cylindrical spindle: LV No. 4), the viscosity at a rotational speed of 5 rpm and the viscosity at a rotational speed of 50 rpm were measured at a measurement temperature of 25° C.

Measurement of Dispersibility of Graphene Dispersion

### Dispersibility-1

The dispersion 1 was left at room temperature (25° C.) for one month, and precipitation and aggregation of graphene were visually confirmed and evaluated.
A: Absolutely no occurrence of precipitation and aggregation.
B: Slight amount of precipitation or aggregation occurred.
C: Numerous occurrences of precipitation or aggregation

### Dispersibility-2

The dispersion 1 was centrifuged for 10 minutes in a centrifuge (model: CN-2060, available from Hitachi Koki Co., Ltd., rotor: RA-1508, 1000 rpm), 1 mL of the dispersion was collected from the top layer and diluted 100-fold with, as a solvent, a mixed solvent of deionized water and 2-propanol (volume ratio: 60/40) to prepare a diluted solution. The absorbance (660 nm) of the prepared diluted solution was measured using a spectrophotometer (V-570, available from JASCO Corporation) and multiplied by 100, and the resulting value was used as the absorbance value.

Evaluation of Dispersibility and Film Formability of Graphene Resin Film

The dispersion 1 was dripped onto a metal foil, applied with a bar coater, and dried for 10 minutes at 85° C. to remove the solvent, and thereby a film having a thickness of 5 μm was formed. The dispersibility and film formability of the resulting graphene resin film were visually evaluated.

### Dispersibility

A: No aggregation
B: Some aggregation
C: Aggregation throughout entire film

### Film Formability

A: Uniform continuous film is obtained.
B: Locations are present in which a uniform continuous film is not formed in portions.
C: A film cannot be formed.

Evaluation of Electrical Conductivity

The surface resistance of the graphene resin film having a thickness of 30 μm and formed by the method described above was measured using a Loresta resistivity meter (available from Mitsubishi Chemical Analytech Co., Ltd.). Note that the surface resistance value may be 1.0 Ω/square or less, and may be 1.0×10⁻¹ Ω/square or less.

Evaluation of Dispersibility of Graphene Resin Powder

The solvent of the dispersion 1 was heated to 100° C. and dried, after which the dried powder was ground in a mortar, and a graphene resin powder coated with a polymer was prepared.
Each graphene resin powder was dissolved in 575 g of a mixed solvent of deionized water and 2-propanol (volume ratio: 60/40) as a solvent at 500 rpm for 10 minutes using a dispersion-type dispersing rotary body (Three-One Motor, available from Shinto Scientific Co., Ltd.) having a weaker force than ultrasonic waves, to thereby prepare a graphene re-dispersion. The graphene re-dispersion was centrifuged for 10 minutes in a centrifuge (model: CN-2060, available from Hitachi Koki Co., Ltd., rotor: RA-1508, 1000 rpm), and 1 mL of the dispersion was collected from the top layer and diluted 100-fold with a solvent to prepare a diluted solution. The absorbance (660 nm) of the prepared diluted solution was measured and multiplied by 100, and the resulting value was used as the absorbance value.

### Examples 2 to 8, Comparative Examples 1 to 5

Graphene dispersions (dispersions 2 to 13) were prepared by the same method as in Example 1 by blending the compositions described in Table 1-1 and Table 1-2. The prepared graphene dispersions (dispersions 2 to 13) were used to carry out the same evaluations as in Example 1. The evaluation results are shown in Table 1-1 and Table 1-2.
Note that specifically, the dispersion 9 in which a polymer was not blended was used as Comparative Example 1, the dispersion 10 in which a surfactant was blended at a predetermined amount in place of the polymer was used as Comparative Example 2, the dispersions 11 and 12 in which that viscosity ratios did not conform to the examples were used as Comparative Examples 3 and 4, and the dispersion 13 in which a nanofiller that expresses electrical conductivity similar to graphene was blended in place of the modified graphite was used as Comparative Example 5.

TABLE 1-1

| | | Example 1 | Example 2 | Example 3 | Example 4 | Example 5 | Example 6 | Example 7 | Example 8 |
|---|---|---|---|---|---|---|---|---|---|
| | | Dispersion 1 | Dispersion 2 | Dispersion 3 | Dispersion 4 | Dispersion 5 | Dispersion 6 | Dispersion 7 | Dispersion 8 |
| Modified graphite amount -1 (g) | | 20.00 | 20.00 | 20.00 | 20.00 | 20.00 | 20.00 | 20.00 | — |
| Modified graphite amount -2 (g) | | — | — | — | — | — | — | — | 20.00 |
| Nanofiller (g) | | — | — | — | — | — | — | — | — |
| Polymer | Carboxymethylated | 28.80 | 14.40 | — | — | — | — | — | — |
| | starch (g) | | | | | | | | |
| | Carboxymethyl | — | — | 7.10 | 3.10 | 1.60 | — | — | 3.10 |
| | cellulose (g) | | | | | | | | |
| | Hydroxyethyl | — | — | — | — | — | 11.40 | — | — |
| | cellulose (g) | | | | | | | | |
| | Polyvinyl alcohol- | — | — | — | — | — | — | 50.00 | — |
| | 1 (g) | | | | | | | | |
| | Polyvinyl alcohol- | — | — | — | — | — | — | — | — |
| | 2 (g) | | | | | | | | |
| | Polyacrylic acid (g) | — | — | — | — | — | — | — | — |
| Surfactant (g) | | — | — | — | — | — | — | — | — |
| Solvent | Water/2-Propanol (g) | 575.00 | 575.00 | 575.00 | 575.00 | 575.00 | 575.00 | 575.00 | 575.00 |
| Graphene | Graphene amount (g) | 4.00 | 4.00 | 4.00 | 4.00 | 4.00 | 4.00 | 4.00 | 3.00 |
| dispersion | Graphene size (μm) | 0.70 | 0.70 | 0.70 | 0.70 | 0.70 | 0.70 | 0.70 | 0.70 |
| | Graphene | 7.0 | 7.0 | 7.0 | 7.0 | 7.0 | 7.0 | 7.0 | 5.2 |
| | concentration (mg/g) | | | | | | | | |
| | Modified graphite | 34.8 | 34.8 | 34.8 | 34.8 | 34.8 | 34.8 | 34.8 | 34.8 |
| | concentration (mg/g) | | | | | | | | |
| | Polymer | 50.1 | 25.0 | 12.3 | 5.4 | 2.8 | 19.8 | 87.0 | 5.4 |
| | concentration (mg/g) | | | | | | | | |
| | 5 rpm viscosity | 36000 | 12000 | 5700 | 1500 | 600 | 13000 | 3150 | 1200 |
| | (mPa · s) | | | | | | | | |
| | 50 rpm viscosity | 8000 | 4000 | 3000 | 1000 | 500 | 3500 | 900 | 800 |
| | (mPa · s) | | | | | | | | |
| | Viscosity ratio | 4.5 | 3.0 | 1.9 | 1.5 | 1.2 | 3.7 | 3.5 | 1.5 |
| Properties | Graphene dispersion | A | A | A | A | A | A | A | A |
| | dispersibility -1 | | | | | | | | |
| | Graphene dispersion | 105 | 105 | 140 | 130 | 120 | 115 | 100 | 110 |
| | dispersibility -2 | | | | | | | | |
| | (absorbance value) | | | | | | | | |
| | Graphene resin film | A | A | A | A | A | A | A | A |
| | dispersibility | | | | | | | | |
| | Film formability of | A | A | A | A | A | A | A | A |
| | graphene resin film | | | | | | | | |
| | Graphene resin film | 2.0 × 10⁻¹ | 3.0 × 10⁻¹ | 1.5 × 10⁻² | 1.0 × 10⁻² | 5.0 × 10⁻¹ | 5.0 × 10⁻¹ | 1.0 × 10⁻¹ | 3.0 × 10⁻¹ |
| | surface resistance | | | | | | | | |
| | (Ω/square) | | | | | | | | |
| | Dispersibility | 95 | 100 | 130 | 120 | 110 | 105 | 90 | 100 |
| | (absorbance value) of | | | | | | | | |
| | graphene resin powder | | | | | | | | |
| Battery | High discharge | A | A | A | A | A | A | B | A |
| properties | capacity retention rate | | | | | | | | |

TABLE 1-2

| | | Comparative | Comparative | Comparative | Comparative | Comparative |
|---|---|---|---|---|---|---|
| | | Example 1 | Example 2 | Example 3 | Example 4 | Example 5 |
| | | Dispersion 9 | Dispersion 10 | Dispersion 11 | Dispersion 12 | Dispersion 13 |
| Modified graphite amount -1 (g) | | 20.00 | 20.00 | 20.00 | 20.00 | — |
| Modified graphite amount -2 (g) | | — | — | — | — | — |
| Nanofiller (g) | | — | — | — | — | 20.00 |
| Polymer | Carboxymethylated | — | — | — | — | — |
| | starch (g) | | | | | |
| | Carboxymethyl | — | — | — | — | 7.10 |
| | cellulose (g) | | | | | |
| | Hydroxyethyl | — | — | — | — | — |
| | cellulose (g) | | | | | |
| | Polyvinyl alcohol- | — | — | — | — | — |
| | 1 (g) | | | | | |
| | Polyvinyl alcohol- | — | — | 173.00 | — | — |
| | 2 (g) | | | | | |
| | Polyacrylic acid (g) | — | — | — | 230.00 | — |
| Surfactant (g) | | — | 3.10 | — | — | — |
| Solvent | Water/2-Propanol (g) | 575.00 | 575.00 | 575.00 | 575.00 | 575.00 |
| Graphene | Graphene amount (g) | 4.00 | 4.00 | 4.00 | 4.00 | — |
| dispersion | Graphene size (μm) | 0.70 | 0.70 | 0.70 | 0.70 | — |
| | Graphene | 7.0 | 7.0 | 7.0 | 7.0 | — |
| | concentration (mg/g) | | | | | |
| | Modified graphite | 34.8 | 34.8 | 34.8 | 34.8 | — |
| | concentration (mg/g) | | | | | |
| | Polymer | 0.0 | 0.0 | 300.9 | 400.0 | 12.3 |
| | concentration (mg/g) | | | | | |
| | 5 rpm viscosity | 100 | 110 | 4200 | 550 | 11200 |
| | (mPa · s) | | | | | |
| | 50 rpm viscosity | 100 | 110 | 700 | 500 | 4000 |
| | (mPa · s) | | | | | |
| | Viscosity ratio | 1.0 | 1.0 | 6.0 | 1.1 | 2.8 |
| Properties | Graphene dispersion | C | B | A | B | A |
| | dispersibility -1 | | | | | |
| | Graphene dispersion | 0 | 20 | 100 | 50 | 50 |
| | dispersibility -2 | | | | | |
| | (absorbance value) | | | | | |
| | Graphene resin film | C | B | B | B | B |
| | dispersibility | | | | | |
| | Film formability of | C | C | B | B | A |
| | graphene resin film | | | | | |
| | Graphene resin film | Not | Not | 6.0 × 10⁶ | 5.5 × 10⁷ | Not |
| | surface resistance | measurable | measurable | | | measurable |
| | (Ω/square) | | | | | |
| | Dispersibility | 0 | 2 | 90 | 30 | 10 |
| | (absorbance value) of | | | | | |
| | graphene resin powder | | | | | |
| Battery | High discharge | D | D | D | D | D |
| properties | capacity retention rate | | | | | |

Note that details of the blended components described in Tables 1-1 and 1-2 are as follows.
Modified graphite-2 (available from XG Sciences, Inc., grade M, size (long side): 25 μm, number of layers: 20)
Nanofiller (alumina nanofiller, trade name: AA-03, available from Sumitomo Chemical Co., Ltd., size 0.4 μm)
Carboxymethylated starch (trade name: carboxymethylated starch, available from Nippon Starch Chemical Co., Ltd., weight-average molecular weight: 340000, degree of etherification: 0.90 to 1.10)
Carboxymethyl cellulose (trade name: MAC350HC, available from Nippon Paper Industries Co., Ltd., weight-average molecular weight: 340000, degree of etherification: 0.78 to 0.88)
Hydroxyethyl cellulose (trade name: HEC-CF-H, available from Sumitomo Seika Chemicals Co., Ltd., weight-average molecular weight: 700000, degree of etherification: 0.90 to 1.20)
Polyvinyl alcohol-1 (trade name: EG-05C, available from Mitsubishi Chemical Corporation, weight-average molecular weight: 120000, degree of saponification: 87 mol %)
Polyvinyl alcohol-2 (trade name: PVA-217, available from Kuraray Co., Ltd., weight-average molecular weight: 1700)
Polyacrylic acid (trade name: DL-100, available from Nippon Shokubai Co., Ltd., weight-average molecular weight: 3500)
Surfactant (trade name: Neopelex G-65, available from Kao Corporation, molecular weight: 350)

In this manner, graphene and a polymer having a weight-average molecular weight of from 10000 to 800000 were dispersed in a solvent and adjusted to prepare a graphene dispersion having a viscosity of from 500 to 10000 (mPa·s) measured using a B-type viscometer at a measurement temperature of 25° C. and a rotational speed of 50 rpm. The graphene dispersion was also adjusted such that a value (viscosity ratio) obtained by dividing the viscosity of the graphene dispersion measured using the B-type viscometer at a measurement temperature of 25° C. and a rotational speed of 5 rpm by the viscosity of the graphene dispersion measured using the B-type viscometer at a measurement temperature of 25° C. and a rotational speed of 50 rpm was from 1.2 to 5.0 (to form a thixotropic dispersion (to form a dispersion with structural viscosity)). Thereby, a graphene dispersion that exhibits excellent dispersibility and from which can be formed a graphene resin film with high electrical conductivity was obtained. This is evident from a comparison between Examples 1 to 8 and Comparative Examples 1 to 5.

Preparation of Negative Electrode Graphene Dispersion

A mixture was obtained by inserting 10.00 g of a graphene resin powder produced from dispersion 1, 85.00 g of spherical graphite as a negative electrode active material, 5.00 g of a negative electrode binder, and 122.0 g of a mixed solvent of deionized water and 2-propanol (volume ratio: 60/40) into a planetary mixer and kneading in a vacuum state. The obtained mixture was further mixed with a 48% aqueous dispersion of a styrene-butadiene emulsion as a graphene dispersion binder for a negative electrode, and a negative electrode graphene dispersion having a solid content concentration of 45% was obtained. The dispersions 2 to 13 were also prepared in the same manner.

Production of Battery Negative Electrode Mixture Layer

A battery electrode mixture layer was produced using a negative electrode graphene dispersion and a copper foil (thickness 18 μm) serving as a current collector. The negative electrode graphene dispersion was applied at a predetermined thickness using a doctor blade. The coated copper foil was vacuum dried for 1 hour at 120° C. and punched to 18 mmΦ. The punched battery negative electrode mixture layer was sandwiched between ultra-steel press plates and pressed at a pressing pressure on the battery negative electrode mixture layer of from 1000 to 3000 kg/cm². The basis weight was from 7 to 9 mg/cm², the thickness was from 40 to 60 μm, and the electrode density was 1.6 g/cm³. Subsequently, the battery negative electrode mixture layer was dried at 120° C. for 12 hours in a vacuum dryer to form a negative electrode for evaluation.

Production of Positive Electrode

A positive electrode mixed slurry having a solid content concentration of 67% was prepared by adding 90.00 g of lithium nickelate as a positive electrode active material, 5.00 g of acetylene black (HS-100 available from Denka Co., Ltd.) as a conductive aid, 5.00 g of KF Polymer W7300 (PVDF) as a positive electrode binder, and NMP into a planetary mixer and mixing. The positive electrode mixed slurry was applied at a predetermined thickness onto an aluminum foil (thickness 10 μm) using a doctor blade. The coated foil was vacuum dried for 1 hour at 120° C. and punched to 18 mmΦ. In addition, the punched electrode was sandwiched between ultra-steel press plates and pressed at a pressing pressure on the electrode of from 1000 to 3000 kg/cm². Subsequently, the electrode was dried at 120° C. for 12 hours in a vacuum dryer to form an electrode for evaluation. The electrode was approximately 80 μm thick and had an electrode density of approximately 3.5 g/cm³.

High Discharge Capacity Retention Rate

Constant-current/constant-voltage charging/discharging tests were conducted using the cell produced above for a lithium-ion battery test.
For charging, constant current charging was implemented at 3.6 mA/cm² from the rest potential to 4.3 V. Next, the test was switched to constant voltage charging at 4.3 V, and charging was stopped when the current value dropped to 15.0 μA. For discharging, constant current discharging was implemented at each current density (3.6 mA/cm² (equivalent to 0.1 C) and 72.0 mA/cm² (equivalent to 2.0 C)), and discharging was cut off at a voltage of 2.8 V. The ratio of the discharge capacity at 2.0 C to the discharge capacity at 0.1 C was evaluated as the high discharge capacity retention rate. The high discharge capacity retention rate was evaluated on the basis of the following criteria. The results of the evaluation based on the following criteria are shown in Table 1-1 and Table 1-2.
A (excellent): High discharge capacity retention rate of 95% or greater, which is within the acceptable range.
B (good): High discharge capacity retention rate of from 90% to less than 95%, which is within the acceptable range.
C (somewhat inferior): High discharge capacity retention rate of from 80% to less than 90%, which is within the acceptable range.
D (inferior): High discharge capacity retention rate of less than 80%, which is unacceptable.

Binder
Styrene-butadiene emulsion (SBR) (trade name: TRD2001, available from JSR Corporation, aqueous dispersion with solid content of 48%) as a binder for a negative electrode graphene dispersion
Polyvinylidene fluoride (PVDF) (trade name: KF Polymer W7300, available from Kureha Corporation, weight-average molecular weight of approximately 1000000) as a positive electrode binder

### Electrode Active Material

Positive electrode active material: lithium nickel (trade name: 503LP, available from JFE Mineral Co., Ltd., average particle size of 11 μm)
Negative electrode active material: Spherical graphite (trade name: CGB-20, available from Nippon Graphite Industries, Co., Ltd., average particle size of 20 μm)

From Table 1-1 and Table 1-2, it was found that the batteries of Examples 1 to 8 exhibited better results for the high discharge capacity retention rate than the batteries of Comparative Examples 1 to 5. In particular, the results demonstrate that an electrode layer of a secondary battery excelling in a high discharge capacity retention rate can be obtained with high dispersibility (absorbance) of a graphene resin powder and good film formability of a graphene resin film.

1. A graphene dispersion in which graphene and a polymer are dispersed or dissolved in a solvent, wherein
a weight-average molecular weight of the polymer is from 10000 to 800000,
a viscosity of the graphene dispersion measured using a B-type viscometer at a measurement temperature of 25° C. and a rotational speed of 50 rpm is from 500 to 10000 (mPa·s), and
a value obtained by dividing a viscosity of the graphene dispersion measured using the B-type viscometer at a measurement temperature of 25° C. and a rotational speed of 5 rpm by the viscosity of the graphene dispersion measured using the B-type viscometer at a measurement temperature of 25° C. and a rotational speed of 50 rpm is from 1.2 to 5.0.

2. The graphene dispersion according to claim 1, wherein
the polymer is an anionic polymer having at least one functional group selected from the group consisting of a carbonyl group, a hydroxyl group, a sulfonate group, and a phosphate group.

3. The graphene dispersion according to claim 1, wherein
a content of the polymer in relation to the solvent is from 1 to 100 mg/g.

4. The graphene dispersion according to claim 1, wherein
the solvent is a mixed solvent containing water and an alcohol.

5. A graphene resin powder obtained by drying the graphene dispersion described according to claim 1.

6. A battery in which the graphene resin powder described in claim 5 is used.
